(19) United States
(12) Patent Application Publication
(10) Pub. No.: US 2026/0039542 A1
(43) Pub. Date: Feb. 5, 2026

(54) USING GENERATIVE ARTIFICIAL INTELLIGENCE (AI) TO ON-BOARD NETWORK DEVICES

(71) Applicant: Cisco Technology, Inc., San Jose, CA (US)

(72) Inventors: Jerome Henry, Pittisboro, NC (US); Robert Edgar Barton, Richmond (CA); Vinay Saini, Bangalore (IN)

(21) Appl. No.: 18/794,922

(22) Filed: Aug. 5, 2024

(51) Int. Cl. H04L 41/0806; G06F 40/40; H04L 12/46; H04L 41/16

(52) U.S. Cl. CPC H04L 41/0806; G06F 40/40; H04L 12/4679; H04L 41/16

(57) ABSTRACT

Techniques for on-boarding of devices using language models are described herein. A controller of a network may receive profiling information associated with a device that made an initial connection to the network. The controller may determine a type associated with the device based on the profiling information and query a database to identify a workflow for on-boarding the device of that type. The controller may request a configuration script to configure the device with the network from one or more generative artificial intelligence (AI) language models. The language model(s) may generate the configuration script by translating the profiling information of the device and the workflow associated with the device into a configuration script. The language model(s) may output a configuration script for configuring the device with the network to the controller, where the controller may configure a network port associated with the device upon execution of the configuration script.

### TECHNICAL FIELD

The present disclosure relates generally to, among other things, techniques for leveraging generative artificial intelligence (AI) to automate on-boarding of network devices.

### BACKGROUND

In various types of networks, the on-boarding process for new devices connecting to the network has always been a challenge, particularly when on-boarding non-human devices, such as, cameras, sensors, human machine interfaces (HMIs), programmable logic controllers (PLC), Internet of Things (IoT) devices, and the like. These non-human devices present additional challenges during the on-boarding process given that devices of such a type typically do not support identity services, which makes it difficult for the network to understand how to configure them. Typically, the on-boarding process for non-human devices (and human controlled devices) involves action from a network administrator. For example, a network administrator may be required to manually assign the device the correct virtual local area network (VLAN), manually place the device in the correct domain, and/or provisioning the required and/or proper security policies on the device. This adds additional burden to network administrators in networks where many human controlled devices (e.g., a personal computer, a mobile phone, and/or the like) and/or non-human devices of the same type and/or different types are being on-boarded at once. Thus, there is a need to automate the on-boarding process for devices that are attaching to networks.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example environment and flow for performing the automated on-boarding techniques disclosed herein.

FIG. 2 illustrates a flow diagram of an example method for performing the automated on-boarding techniques disclosed herein.

FIG. 3 illustrates a computing system diagram illustrating a configuration for a data center that can be utilized to implement aspects of the technologies disclosed herein.

FIG. 4 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes method(s) to leverage generative artificial intelligence (AI) to automate on-boarding of network devices. The method may include receiving, at a network controller associated with a network and from a profiling server associated with the network, profiling information associated with a device that has made an initial connection to the network. Additionally, or alternatively, the method may include determining, based at least in part on the profiling information, a type associated with the device. Additionally, or alternatively, the method may include querying a database to identify a workflow associated with on-boarding the device based at least in part on the type associated with the device. Additionally, or alternatively, the method may include sending, from the network controller and to a language model associated with the network, a request for a configuration script associated with configuring the device with the network, the request including the workflow associated with on-boarding the device and the profiling information associated with the device. Additionally, or alternatively, the method may include receiving, at the network controller and from the language model, the configuration script associated with the device, the configuration script being associated with a network port of a switch connecting the device to the network. Additionally, or alternatively, the method may include configuring, by the network controller, the network port associated with the device based at least in part on execution of the configuration script.

The techniques described herein may be performed as a method and/or by a system having non-transitory computer-readable media storing computer-executable instructions that, when executed by one or more processors, cause the system to perform the techniques described above and herein.

### Example Embodiments

As previously described, the on-boarding process for new devices connecting to various networks (e.g., computing resource networks, cloud networks, wide-area networks, software-defined networks, and/or the like) has always been a challenge, particularly when on-boarding non-human devices, such as, cameras, sensors, human machine interfaces (HMIs), programmable logic controllers (PLC), Internet of Things (IoT) devices, and the like. These non-human devices present additional challenges during the on-boarding process given that devices of such a type typically do not support identity services, which makes it difficult for the network to understand how to configure them. Typically, the on-boarding process for non-human devices (and human controlled devices) involves action from a network administrator. For example, a network administrator may be required to manually assign the device the correct virtual local area network (VLAN), manually place the device in the correct domain, and/or provisioning the required and/or proper security policies on the device. This adds additional burden to network administrators in networks where many human and/or non-human devices of the same type and/or different types are being on-boarded at once.

This application describes techniques for leveraging language models, such as, for example, large language models (LLMs), medium language models (MLMs), small language models (SLMs), generative artificial intelligence (AI) models, and/or the like to automate the on-boarding process of network devices. In some examples, a network controller provisioned in a computing resource network may be configured to on-board devices connecting to the network by leveraging a generative AI model, having knowledge of contextual details of the network where the device is being added and being configured to generate configuration script(s), and execute the configuration scripts output by the generative AI model. That is, a network controller may obtain profiling information associated with a device that has attached to the network to identify a workflow for on-boarding the device based on a type of the device derived from the profiling information. Additionally, or alternatively, the one or more language models (e.g., the generative AI model) accessible by the network controller may be leveraged to generate the configuration script based on the identified workflow and the profiling information to configure, or otherwise on-board the device with the network. That is, the language model may be fine-tuned with knowledge of generalized configuration profiles for a wide variety of devices to generate a configuration script for on-boarding of the device. The network controller may be configured to collect detailed information about a device being added to the network, along with context associated with the network itself, and feed this information into a language model that is configured to generate the on-boarding configuration for the device in a format (e.g., a configuration script) that the controller may execute.

A computing resource network may be configured with a network controller and/or one or more profiling services. In some examples, the profiling services may be configured to gather information about a device that is being introduced to the network. Such profiling services may include Cisco Discovery Protocol (CDP), link layer discovery protocol (LLDP), and/or the like. The information associated with the device that is collected may include, but is not limited to, a device identifier (ID), and internet protocol (IP) address associated with the device, a manufacturer of the device, one or more capabilities associated with the device, and/or power over ethernet (PoE) information associated with the device. Additionally, or alternatively, other information associated with the device may be gathered by a profiling server (e.g., an identity services engine (ISE)) if available depending on the device (e.g., user devices that have to verify user identity via identity services). In some examples, the computing resource network may also include a profiling server (also referred to herein as a policy server) for collecting the additional information associated with the device and/or one or more language model(s), such as, for example, LLMs, MLMs, SLMs, and/or generative AI models. Additionally, or alternatively, the profiling server and/or the language models may be hosted externally from the computing resource network (e.g., in a cloud network and/or the like) and configured to be accessible by the network controller and/or the computing resource network.

The profiling server may include one or more profiling databases containing profiling information associated with various devices (e.g., information collected via CDP, LLDP, ISE profiling, and/or the like). In some examples, the profiling database may include generalized device-type templates, or workflows, that describe how devices of a certain type should be configured on the network. For example, the profiling database may indicate that all programmable logic controller (PLC) devices must be on a particular ethernet VPN (EVPN) overlay. This profiling database may be accessible by the network controller such that the network controller may query the database using a semantic search, providing all of the details/criteria associated with a device to find which workflow it best translates to. That is, the network controller may query this information and learn how a device of a certain type should be handled in a general way, without the device specific details (e.g., receiving a template workflow for on-boarding).

As described above, the language model(s) may be configured as an LLM, an MLM, an SLM, and/or a generative AI model. In some examples, the language models may be configured as a generative AI model comprising an LLM, an MLM, an SLM, and/or the like. Additionally, or alternatively, the MLM and/or the SLM may be generated as a result of one or more distillation process performed by an administrator of the network with respect to an LLM. That is, an MLM and/or SLM may be configured as a language model that is hyper focused on a smaller number of tasks than that of the LLM from which it is derived. The language models may be fine-tuned with knowledge of generalized configuration profiles for a wide variety of devices. For examples, the language models may be configured to make a best guess for a given device (e.g., a human machine interface (HMI) made by a particular manufacturer) with respect to certain best practice network configurations for the device, such as, for example, how the switchports quality of service (QoS) should be configured (e.g., network speed, security services, etc.). That is, the language models may take a workflow template for a particular device as input from the network controller and fill in the missing details of the workflow with generative AI techniques and add them to the provided workflow file output as an configuration file comprising various automation tasks. In some examples, the language models may be trained through a retrieval-augmented generation (RAG) exercise of existing devices in the network. Additionally, or alternatively, the language models may be trained based on specially prepared datasets provided by device vendors/manufacturers. The language models may also be tuned between low and high bounds as to how creative a network administrator would like them to be. For example, a language model with low creativity may be configured to output configuration scripts for devices it knows how to handle while requesting assistance from the network administrator for devices it has not previously on-boarded before. Whereas a language model with high creativity may be configured to output configuration scripts for any device, regardless of its knowledge with respect to the device, and it may output different configuration scripts for two separate devices that are the same, leading to some unexpected results. As such, a fine-tuning of the model to a moderate level of creativity may be best as it allows the language models freedom to on-board devices that are slightly different from those in the past that it has handled (e.g., a new version of a device) while still maintaining consistency in delivering expected results for the devices it knows how to on-board.

Take, for example, an environment including a computing resource network comprising a network controller and one or more profiling service(s), a profiling server comprising a profiling database, and/or a language model server comprising one or more language models. In some examples, the computing resource network may be attached to one or more access switches that connect devices to the computing resource network. Additionally, or alternatively, the computing resource network may provide one or more overlay network(s) for use by devices that have been configured (or on-boarded) for use of the computing resource network. As described above, the network controller may be configured to on-board devices connecting to the network by leveraging a language model, having knowledge of contextual details of the network where the device is being added, configured to generate configuration script(s), and the network controller may execute the configuration scripts output by the language model.

For example, a new device may connect to an access switch associated with the computing resource network. In some examples, the device may be a non-human device (e.g., an IoT device) or a human device (e.g., a mobile phone). Upon connecting to the network, the device may be introduced to the computing resource network in a quarantine VLAN configured to have limited access to service(s) of the network, but may be accessed by the profiling server. The profiling server (e.g., ISE) and/or profiling services (e.g., CDP, LLDP, and/or the like) of the computing resource network may then profile the device to gather information about the device, such as, for example, a device ID, an IP address associated with the device, a manufacturer associated with the device, one or more capabilities associated with the device, power over ethernet (PoE) information associated with the device, a manufacturer usage description (MUD) uniform resource indicator (URI) associated with the device, and/or the like. This profiling information associated with the device that has made an initial connection to the computing resource network may then be sent to the network controller, providing the network controller a detailed description of the device learned from the network.

The network controller may be configured to determine a type associated with the device based on the profiling information received from the profiling server and/or the profiling services. In some examples, the network controller may utilize the profiling information and/or the type of the device to query a profiling database for a workflow associated with on-boarding the device with the network. That is, the network controller may perform a semantic search, providing the profiling information and/or the type of the device as criteria for the semantic search, to identify a workflow template that best translates to the device. Once the network controller determines the workflow best fit for the device, the network controller may utilize the language models to translate the information it has about the device into an automation task for configuration of the network port where the device is connected.

For example, the network controller may send a request for a configuration script to the language model(s). In some examples, the language models may be hosted in the computing resource network and directly accessed by the network controller. Additionally, or alternatively, the language models may be hosted externally from the computing resource network, such as, for example, in a remote cloud network that is accessible by the network controller. The request may include the workflow associated with on-boarding the device and/or the profiling information associated with the device. Since language models (particularly generative AI models) are exceptionally good at translation, the network controller may leverage the language models to translate the profiling information learned about the device into a configuration script using the workflow template provided, resulting in a configuration script comprising various automation tasks for configuration aspects for the switch port where the device is connected, such as, for example, which overlay network the device should be assigned to, which VLAN should be assigned to the device, QoS requirements for the device, security configurations for the port, and/or the like.

The network controller may then receive the configuration script for the device from the language models. Once received, the controller may execute the configuration script to configure the network port associated with the device. As a result of execution of the configuration script, the device may transition from an on-boarding state (executing in a quarantine VLAN) to a fully connected and functional state (executing in another VLAN that has greater access to the network than the quarantine VLAN) including all of the services that the device requires. For example, execution of the configuration script may result in assigning the device to an overlay network provided by the computing resource network, assigning the device to a particular VLAN fit for the device, configuring one or more QoS attributes associated with the device, configuring the network port where the device is connected with one or more security services required by the device, and/or the like.

As described herein, a computing-based, network-based, cloud-based service, network device, switch, and/or server can generally include any type of resources implemented by virtualization techniques, such as containers, virtual machines, virtual storage, and so forth. Further, although the techniques described as being implemented in data centers and/or a cloud computing network, the techniques are generally applicable for any network of devices managed by any entity where virtual resources are provisioned. In some instances, the techniques may be performed by a schedulers or orchestrator, and in other examples, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect to on-boarding of network devices. For instance, the techniques described herein include leveraging language models, such as, for example, generative AI models, to translate profiling information associated with a device into a configuration script using a workflow template. By leveraging language models, a high level of accuracy can be realized when translating the profiling information into a configuration script. In addition, the language models may be configured to generate the automations script based on best-practice configuration models for various devices, finely tuned by a network administrator performing RAG exercise(s) of existing devices in the network. Further, the language models may be configured such that a network administrator may tune the model to be more or less creative when generating the configuration scripts, such that the language models may generate configuration scripts for devices that have not yet been encountered by the network but are within a threshold similarity to devices that have previously been on-boarded (e.g., a new version of a given device) while still producing expected results for devices that are known. As a result, when a new device attaches to the network, the device may be automatically on-boarded without intervention by a network administrator. Thus, reducing the burden for a network administrator on-boarding a large number of devices (e.g., school tablets/laptops, sensors/cameras in commercial buildings). Additionally, by automating the on-boarding process, devices can utilize the computing resource network more quickly than if a network administrator were to configure the device manually. The techniques described herein also increase network security as the language models are trained using best practice device configurations, ensuring that the configured devices are provisioned with proper security functionality.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

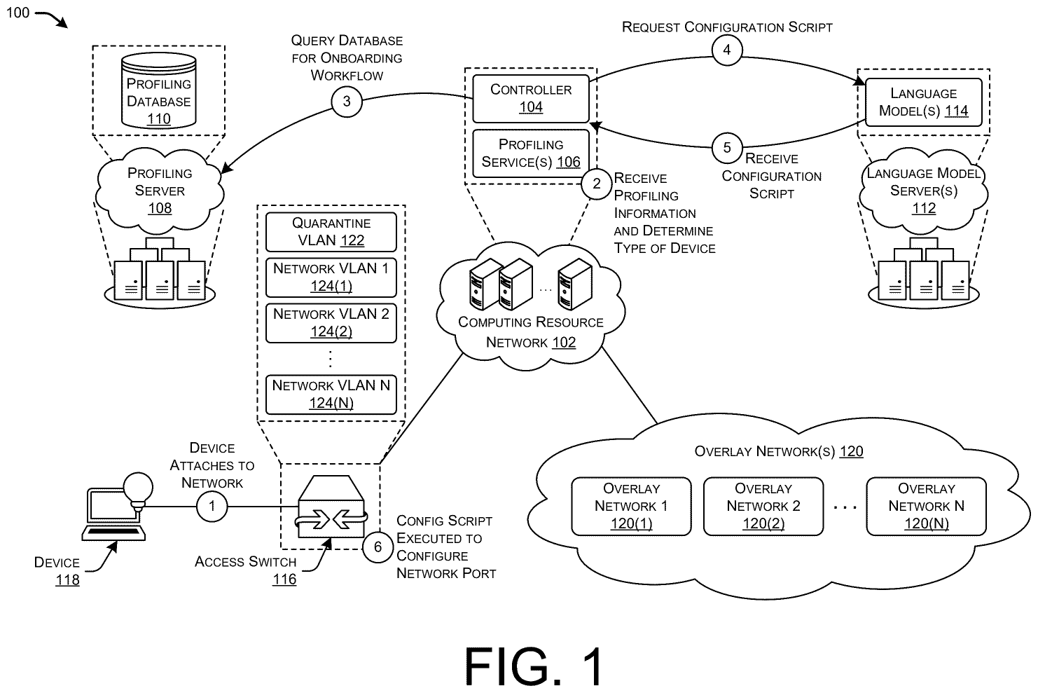

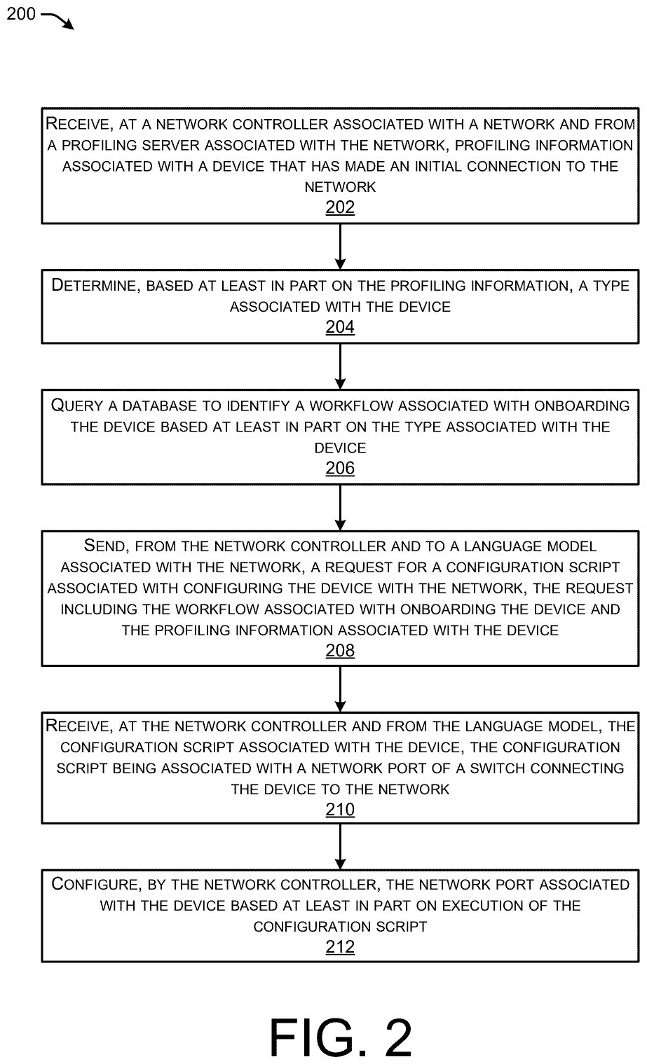

FIGS. 1 and 2 illustrate flow diagrams of example methods (or flows) 100 and 200 that illustrate aspects of the functions performed at least partly by the computing resource network 102 of a network as described in FIG. 1. The logical operations described herein with respect to FIGS. 1 and 2 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 1 and 2, and as described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 1 illustrates a system-architecture diagram of an example environment 100 and flow for a computing resource network 102 to perform the automated on-boarding techniques disclosed herein. Generally, the computing resource network 102 may include devices that are housed or located in one or more data centers that may be located at different physical locations. For instance, the computing resource network 102 may be supported by networks of devices in a public cloud computing platform, a private/enterprise computing platform, and/or any combination thereof. The one or more data centers may be physical facilities or buildings located across geographic areas that are designated to store networked devices that are part of the computing resource network 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the computing resource network 102 may not be located in explicitly defined data centers and, rather, may be located in other locations or buildings.

The environment 100 may include a computing resource network 102 comprising a network controller 104 and one or more profiling service(s) 106, a profiling server 108 comprising a profiling database 110, and/or a language model server 112 comprising one or more language models 114. In some examples, the computing resource network 102 may be attached to one or more access switch(es) 116 that provide device(s) 118 access to the computing resource network 102. Additionally, or alternatively, the computing resource network 102 may provide one or more overlay network(s) 120(1)-(N) for use by device(s) 118 that have been configured (or on-boarded) for use of the computing resource network 102, where N may be any integer greater than 1. Although the profiling server 108 and the language model server 112 are illustrated as disparate from the computing resource network 102, it should be understood that the computing resource network 102 may comprise a profiling server 108 and/or a language model server 112 local to the computing resource network 102.

The computing resource network 102 may provide on-boarding capabilities to devices 118 via access switch(es) 116 connected to the computing resource network 102 over one or more networks, such as the internet. The computing resource network 102, the profiling server 108, and/or the language model server 112, may each respectively include one or more networks implemented by any viable communication technology, such as wired and/or wireless modalities and/or technologies. The computing resource network, the profiling server 108, and/or the language model server 112 may each include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The computing resource network 102 may include devices, virtual resources, or other nodes that relay packets from one network segment to another by nodes in the computer network.

In some examples, the profiling services 106 may be configured to gather information about a device 118 that is being introduced to the computing resource network 102. Such profiling services 106 may include Cisco Discovery Protocol (CDP), link layer discovery protocol (LLDP), and/or the like. The information associated with the device 118 that is collected may include, but is not limited to, an identifier (ID) associated with the device 118, and internet protocol (IP) address associated with the device 118, a manufacturer of the device 118, one or more capabilities associated with the device 118, and/or power over ethernet (PoE) information associated with the device 118. Additionally, or alternatively, other information associated with the device 118 may be gathered by the profiling server 108 (e.g., an identity services engine (ISE)) if available depending on the device 118 (e.g., user devices that have to verify user identity via identity services).

The profiling server 108 may include one or more profiling databases 110 containing profiling information associated with various devices 118 (e.g., information collected via CDP, LLDP, ISE profiling, and/or the like). In some examples, the profiling database 110 may include generalized device-type templates, or workflows, that describe how devices 118 of a certain type should be configured on the computing resource network 102. For example, the profiling database 110 may indicate that all programmable logic controller (PLC) devices must be on a particular ethernet VPN (EVPN) overlay 120. This profiling database 110 may be accessible by the network controller 104 such that the network controller 104 may query the database 110 using a semantic search, providing all of the details/criteria associated with a device 118 to find which workflow it best translates to. That is, the network controller 104 may query this information and learn how a device 118 of a certain type should be handled in a general way, without the device specific details (e.g., receiving a template workflow for on-boarding).

The language model(s) 114 may be configured as an LLM, an MLM, an SLM, and/or a generative AI model. In some examples, the language models 114 may be configured as a generative AI model comprising an LLM, an MLM, an SLM, and/or the like. Additionally, or alternatively, the MLM and/or the SLM may be generated as a result of one or more distillation process performed by an administrator of the computing resource network 102 with respect to an LLM. That is, an MLM and/or SLM may be configured as a language model 114 that is hyper focused on a smaller number of tasks than that of the LLM from which it is derived. The language models 114 may be fine-tuned with knowledge of generalized configuration profiles for a wide variety of devices 118. For examples, the language models 114 may be configured to make a best guess for a given device 118 (e.g., a human machine interface (HMI) made by a particular manufacturer) with respect to certain best practice network configurations for the device 118, such as, for example, how the switchports quality of service (QoS) should be configured (e.g., network speed, security services, etc.). That is, the language models 114 may take a workflow template for a particular device 118 as input from the network controller 104 and fill in the missing details of the workflow with generative AI techniques and add them to the provided workflow file output as an configuration file comprising various automation tasks. In some examples, the language models 114 may be trained through a retrieval-augmented generation (RAG) exercise of existing devices 118 in the computing resource network 102. Additionally, or alternatively, the language models 114 may be trained based on specially prepared datasets provided by device vendors/manufacturers. The language models 114 may also be tuned between low and high bounds as to how creative a network administrator would like them to be. For example, a language model 114 with low creativity may be configured to output configuration scripts for devices 118 it knows how to handle (e.g., devices 118 that are the same as those that have been on-boarded previously) while requesting assistance from the network administrator for devices 118 it has not previously on-boarded before. Whereas a language model 114 with high creativity may be configured to output configuration scripts for any device 118, regardless of its knowledge with respect to the device 118, and it may output different configuration scripts for two separate devices 118 that are the same, leading to unexpected results. As such, a fine-tuning of the language models 114 to a moderate level of creativity may be beneficial as it allows the language models 114 a level of creativity to on-board devices 118 that are slightly different from those that have been previously on-boarded (e.g., a new version of a device 118) while still maintaining consistency in delivering expected results for the devices 118 that have been on-boarded previously.

As described above, the network controller 104 may be configured to on-board devices 118 connecting to the computing resource network 102 by leveraging a language model 114, having knowledge of contextual details of the computing resource network 102 where the device 118 is being added and that is configured to generate configuration script(s), and the network controller 104 may execute the configuration scripts output by the language model(s) 114. An example flow for a network controller 104 to automatically on-board devices using language model(s) is described below.

At “1,” a new device 118 may connect to an access switch 116 associated with the computing resource network 102. In some examples, the device 118 may be a non-human device 118 (e.g., an IoT device) or a human device 118 (e.g., a mobile phone). Upon connecting to the computing resource network 102, the device 118 may be introduced to the computing resource network 118 in a quarantine VLAN 122 configured to have limited access to service(s) of the computing resource network 102, but may be accessed by the profiling server 108 and/or profiling services 106. The profiling server 108 (e.g., ISE) and/or profiling services 106 (e.g., CDP, LLDP, and/or the like) of the computing resource network 102 may then profile the device 118 to gather information about the device 118, such as, for example, an ID of the device 118, an IP address associated with the device 118, a manufacturer associated with the device 118, one or more capabilities associated with the device 118, power over ethernet (PoE) information associated with the device 118, a manufacturer usage description (MUD) uniform resource indicator (URI) associated with the device 118, and/or the like.

At “2,” this profiling information associated with the device 118 that has made an initial connection to the computing resource network 102 may then be sent to the network controller 104, providing the network controller 104 a detailed description of the device 118 learned from the profiling server 108 and/or the profiling service(s) 106. The network controller 104 may be configured to determine a type associated with the device 118 based on the profiling information received from the profiling server 108 and/or the profiling services 106.

At “3,” the network controller 104 may utilize the profiling information and/or the type of the device 118 to query a profiling database 110 for a workflow associated with on-boarding the device 118 with the computing resource network 102. That is, the network controller 104 may perform a semantic search, providing the profiling information and/or the type of the device 118 as criteria for the semantic search, to identify a workflow template that best translates to the device 118. Once the network controller 104 determines the workflow best fit for the device 118, the network controller 104 may utilize the language model(s) 114 to translate the information it has about the device 118 into an automation task for configuration of the network port where the device 118 is connected.

At “4,” the network controller 104 may send a request for a configuration script to the language model(s) 114. In some examples, the language models 114 may be hosted in the computing resource network 102 and directly accessed by the network controller 104. Additionally, or alternatively, the language models 114 may be hosted externally from the computing resource network 102, such as, for example, in a remote cloud network (e.g., the language model servers 112) that is accessible by the network controller 104. The request may include the workflow associated with on-boarding the device 118 and/or the profiling information associated with the device 118. Since language models 114 (particularly generative AI models) are exceptionally good at translation, the network controller 104 may leverage the language models 114 to translate the profiling information learned about the device 118 into a configuration script using the workflow template provided, resulting in a configuration script comprising various automation tasks and configuration aspects for the switch port where the device 118 is connected, such as, for example, which overlay network 120 the device 118 should be assigned to, which VLAN 124(1)-(N) should be assigned to the device 118, QoS requirements for the device 118, security configurations for the port, and/or the like, where N may be any integer greater than 1.

At “5,” the network controller 104 may then receive the configuration script for the device 118 from the language models 114.

At “6,” the network controller 104 may execute the configuration script to configure the network port associated with the device 118. As a result of execution of the configuration script, the device 118 may transition from an on-boarding state (executing in a quarantine VLAN 122) to a fully connected and functional state (executing in another VLAN 124 that has greater access to the computing resource network 102 than the quarantine VLAN 122) including all of the services that the device 118 requires. For example, execution of the configuration script may result in assigning the device 118 to an overlay network 120 provided by the computing resource network 102, assigning the device to a particular VLAN 124 fit for the device 118, configuring one or more QoS attributes associated with the device 118, configuring the network port where the device 118 is connected with one or more security services required by the device 118, and/or the like.

FIG. 2 illustrates a flow diagram of an example method 200 for performing the automated on-boarding techniques disclosed herein. In some examples, the method 200 may be performed by the network controller 102 as described with respect to FIG. 1.

At 202, the method 200 may include receiving profiling information associated with a device that has made an initial connection to the network. In some examples, the profiling information may be received at a network controller associated with a network and sent from a profiling server associated with the network. Additionally, or alternatively, the network, the network controller, the profiling server, and/or the device may correspond to the computing resource network 102, the network controller 104, the profiling server 108, and/or the device 118 as described with respect to FIG. 1.

At 204, the method 200 may include determining, based at least in part on the profiling information, a type associated with the device.

At 206, the method 200 may include querying a database to identify a workflow associated with on-boarding the device based at least in part on the type associated with the device. In some examples, the database may correspond to the profiling database 110 associated with the profiling server 108 as described with respect to FIG. 1.

At 208, the method 200 may include sending a request for a configuration script associated with configuring the device with the network. In some examples, the request may be sent from the network controller and to a language model associated with the network. Additionally, or alternatively, the request may include the workflow associated with on-boarding the device and/or the profiling information associated with the device. In some examples, the language model may correspond to the language model(s) 114 as described with respect to FIG. 1.

At 210, the method 200 may include receiving the configuration script associated with the device. In some examples, the configuration script may be received at the network controller and from the language model. Additionally, or alternatively, the configuration script may be associated with a network port of a switch connecting the device to the network. In some examples, the switch may correspond to the access switch 116 as described with respect to FIG. 1.

At 212, the method 200 may include configuring, by the network controller, the network port associated with the device based at least in part on execution of the configuration script.

In some examples, the language model may be configured as a generative AI model comprising at least one of an LLM, an MLM, and/or an SLM.

In some examples, at least one of the MLM and/or the SLM may be generated as a result of one or more distillation processes performed with respect to the LLM based at least in part on input received from an administrator of the network.

In some examples, configuring the network port associated with the device based at least in part on execution of the configuration script may comprise at least one of assigning the device to an overlay network associated with the network, assigning the device to a virtual local area network (VLAN) associated with the network, configuring one or more quality of service (QoS) attributes associated with the device, and/or configuring the network port with one or more security services associated with the device.

In some examples, the device may be assigned a first virtual local area network (VLAN) associated with the network during the initial connection to the network. In some examples, the first VLAN may be configured as a quarantine VLAN. Additionally, or alternatively, the device may be assigned a second VLAN associated with the network following execution of the configuration script. In some examples, the second VLAN may grant greater access to the network than the first VLAN.

In some examples, the device may be a non-human device configured as at least one of an IoT device, a camera, a sensor, an HMI, and/or a PLC. Additionally, or alternatively, the device may be a human device, under control of one or more users and configured as at least one of a mobile device and/or a personal computing device.

In some examples, determining the type associated with the device may be further based at least in part on a manufacturer usage description (MUD) uniform resource identifier (URI) included in the profiling information and indicating the type of the device.

In some examples, the profiling information associated with the device may include at least one of an identifier associated with the device, an internet protocol (IP) address associated with the device, a manufacturer associated with the device, one or more capabilities associated with the device, and/or power over ethernet (PoE) information associated with the device.

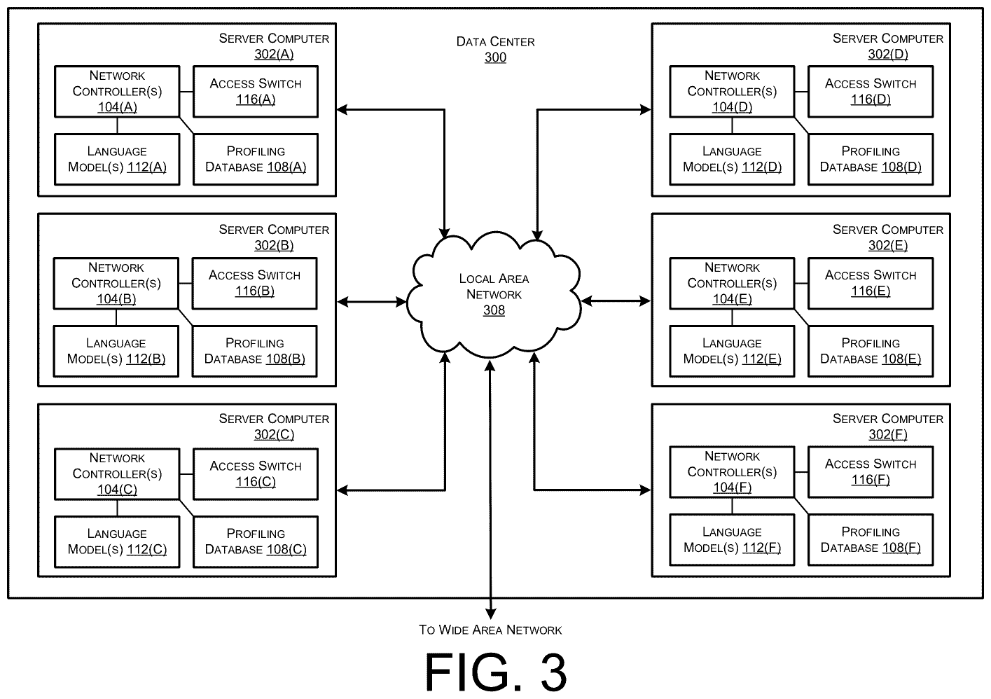

FIG. 3 is a computing system diagram illustrating a configuration for a data center 300 that can be utilized to implement aspects of the technologies disclosed herein. The example data center 300 shown in FIG. 3 includes several server computers 302A-302E (which might be referred to herein singularly as “a server computer 302” or in the plural as “the server computers 302”) for providing computing resources. In some examples, the server computers 302 may include, or correspond to, servers associated with the computing resource network 102, the profiling server(s) 108, and/or the language model server(s) 112 described herein with respect to FIG. 1.

The server computers 302 can be standard tower, rack-mount, or blade server computers configured appropriately for providing the computing resources described herein. As mentioned above, the computing resources provided by the computing resource network 102 can be data processing resources such as VM instances or hardware computing systems, database clusters, computing clusters, storage clusters, data storage resources, database resources, networking resources, and others. Some of the servers 302 can also be configured to execute a resource manager capable of instantiating and/or managing the computing resources. In the case of VM instances, for example, the resource manager can be a hypervisor or another type of program configured to enable the execution of multiple VM instances on a single server computer 302. Server computers 302 in the data center 300 can also be configured to provide network services and other types of services.

In the example data center 300 shown in FIG. 3, an appropriate LAN 308 is also utilized to interconnect the server computers 302A-302E. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 300, between each of the server computers 302A-302E in each data center 300, and, potentially, between computing resources in each of the server computers 302. It should be appreciated that the configuration of the data center 300 described with reference to FIG. 3 is merely illustrative and that other implementations can be utilized.

In some examples, the server computers 302 may each execute a network controller 104, one or more access switch(es) 116, one or more language model(s) 114, and/or one or more profiling database(s) 110.

In some instances, the computing resource network 102, the profiling server(s) 108, and/or the language model server(s) 112, may provide computing resources, like application containers, VM instances, and storage, on a permanent or an as-needed basis. Among other types of functionality, the computing resources provided by the computing resource network 102, the profiling server(s) 108, and/or the language model server(s) 112, may be utilized to implement the various services described above. The computing resources provided by the computing resource network 102, the profiling server(s) 108, and/or the language model server(s) 112, can include various types of computing resources, such as data processing resources like application containers and VM instances, data storage resources, networking resources, data communication resources, network services, and the like.

Each type of computing resource provided by the computing resource network 102, the profiling server(s) 108, and/or the language model server(s) 112, can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The computing resource network 102, the profiling server(s) 108, and/or the language model server(s) 112, can also be configured to provide other types of computing resources not mentioned specifically herein.

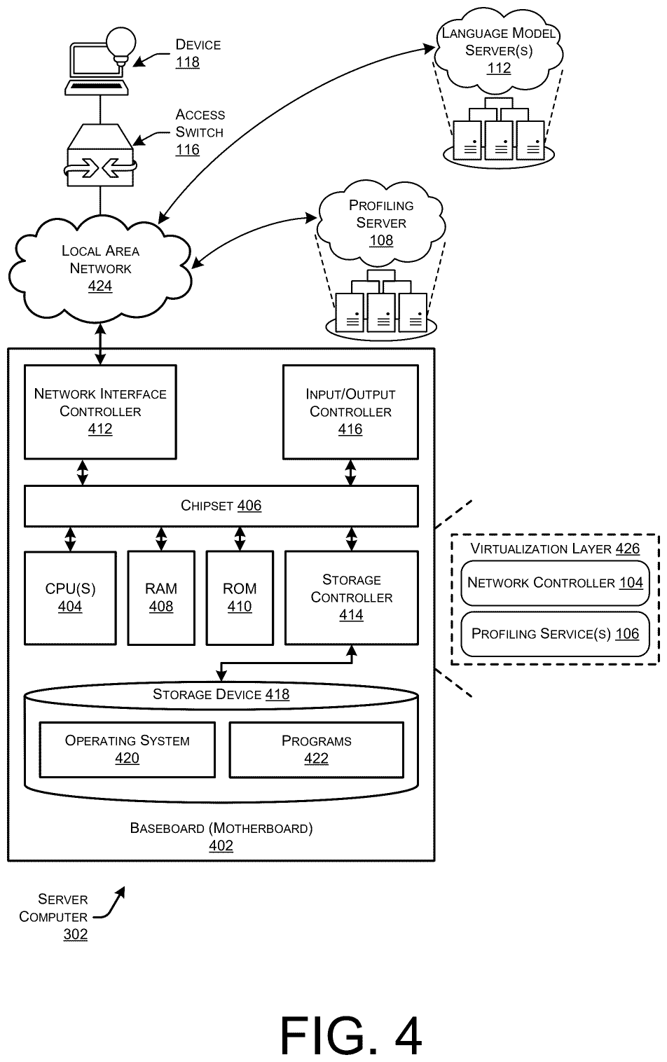

The computing resources provided by the computing resource network 102, the profiling server(s) 108, and/or the language model server(s) 112, may be enabled in one embodiment by one or more data centers 300 (which might be referred to herein singularly as “a data center 300” or in the plural as “the data centers 300”). The data centers 300 are facilities utilized to house and operate computer systems and associated components. The data centers 300 typically include redundant and backup power, communications, cooling, and security systems. The data centers 300 can also be located in geographically disparate locations. One illustrative embodiment for a data center 300 that can be utilized to implement the technologies disclosed herein will be described below with regard to FIG. 4.

FIG. 4 shows an example computer architecture for a computing device (or network routing device) 302 capable of executing program components for implementing the functionality described above. The computer architecture shown in FIG. 4 illustrates a conventional server computer, workstation, desktop computer, laptop, tablet, network appliance, e-reader, smartphone, or other computing device, and can be utilized to execute any of the software components presented herein. The computing device 302 may, in some examples, correspond to a physical server associated with the computing resource network 102, the profiling server(s) 108, and/or the language model server(s) 112 described herein with respect to FIG. 1.

The computing device 302 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 302.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 302. The chipset 406 can further provide an interface to a computer-readable storage medium such as a read-only memory (“ROM”) 410 or non-volatile RAM (“NVRAM”) for storing basic routines that help to startup the computing device 302 and to transfer information between the various components and devices. The ROM 410 or NVRAM can also store other software components necessary for the operation of the computing device 302 in accordance with the configurations described herein.

The computing device 302 can operate in a networked environment using logical connections to remote computing devices and computer systems through a network, such as the network 424 (or 308). The chipset 406 can include functionality for providing network connectivity through a NIC 412, such as a gigabit Ethernet adapter. The NIC 412 is capable of connecting the computing device 302 to other computing devices over the network 424. It should be appreciated that multiple NICs 412 can be present in the computing device 302, connecting the computer to other types of networks and remote computer systems.

The computing device 302 can be connected to a storage device 418 that provides non-volatile storage for the computing device 302. The storage device 418 can store an operating system 420, programs 422, and data, which have been described in greater detail herein. The storage device 418 can be connected to the computing device 302 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 302 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 302 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 302 can further read information from the storage device 418 by detecting the physical states or characteristics of one or more particular locations within the physical storage units.

In addition to the mass storage device 418 described above, the computing device 302 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 302. In some examples, the operations performed by the computing resource network 102, the profiling server(s) 108, and/or the language model server(s) 112, and or any components included therein, may be supported by one or more devices similar to computing device 302. Stated otherwise, some or all of the operations performed by the computing resource network 102, the profiling server(s) 108, and/or the language model server(s) 112, and or any components included therein, may be performed by one or more computing device 302 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 302. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 302.

In one embodiment, the storage device 418 or other computer-readable storage media is encoded with computer-executable instructions which, when loaded into the computing device 302, transform the computer from a general-purpose computing system into a special-purpose computer capable of implementing the embodiments described herein. These computer-executable instructions transform the computing device 302 by specifying how the CPUs 404 transition between states, as described above. According to one embodiment, the computing device 302 has access to computer-readable storage media storing computer-executable instructions which, when executed by the computing device 302, perform the various processes described above with regard to FIGS. 1 and 2. The computing device 302 can also include computer-readable storage media having instructions stored thereupon for performing any of the other computer-implemented operations described herein.

The computing device 302 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 302 might not include all of the components shown in FIG. 4, can include other components that are not explicitly shown in FIG. 4, or might utilize an architecture completely different than that shown in FIG. 4.

The server computer 302 may support a virtualization layer 426, such as one or more components associated with the computing resource network 102, the profiling server(s) 108, and/or the language model server(s) 112. For example, the computing resource network 102 may comprise a network controller 104 and/or one or more profiling service(s) 106. The network controller 104 may be configured to on-board devices 118 connecting to the computing resource network 102 via an access switch 116 by leveraging the language model server 112 providing language model(s) 114 that have knowledge of contextual details of the computing resource network 102 and where the device 118 is being added. For instance, the language models 114 may be configured to generate configuration script(s), and the network controller 104 may execute the configuration scripts output by the language models 114.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A system comprising:
one or more processors; and
one or more non-transitory computer-readable media storing instructions that, when executed by the one or more processors, cause the one or more processors to perform operations comprising:
receiving, at a network controller associated with a network and from a profiling server associated with the network, profiling information associated with a device that has made an initial connection to the network;
determining, based at least in part on the profiling information, a type associated with the device;
querying a database to identify a workflow associated with on-boarding the device based at least in part on the type associated with the device;
sending, from the network controller and to a language model associated with the network, a request for a configuration script associated with configuring the device with the network, the request including the workflow associated with on-boarding the device and the profiling information associated with the device;
receiving, at the network controller and from the language model, the configuration script associated with the device, the configuration script being associated with a network port of a switch connecting the device to the network; and
configuring, by the network controller, the network port associated with the device based at least in part on execution of the configuration script.

2. The system of claim 1, wherein the language model is configured as a generative artificial intelligence (AI) model comprising at least one of:
a large language model (LLM);
a medium language model (MLM); or
a small language model (SLM).

3. The system of claim 2, wherein at least one of the MLM or the SLM is generated as a result of one or more distillation processes performed with respect to the LLM based at least in part on input received from an administrator of the network.

4. The system of claim 1, wherein configuring the network port associated with the device based at least in part on execution of the configuration script comprises at least one of:
assigning the device to an overlay network associated with the network;
assigning the device to a virtual local area network (VLAN) associated with the network;
configuring one or more quality of service (QoS) attributes associated with the device; and
configuring the network port with one or more security services associated with the device.

5. The system of claim 1, wherein:
the device is assigned a first virtual local area network (VLAN) associated with the network during the initial connection to the network, the first VLAN being configured as a quarantine VLAN; and
the device is assigned a second VLAN associated with the network following execution of the configuration script, the second VLAN granting greater access to the network than the first VLAN.

6. The system of claim 1, wherein the device is at least one of:
a non-human device configured as at least one of:
an internet of things (IoT) device;
a camera;
a sensor;
a human machine interface (HMI); or
a programmable logic controller (PLC); or
a human device, under control of one or more users and configured as at least one of:
a mobile device; or
a personal computing device.

7. The system of claim 1, wherein determining the type associated with the device is further based at least in part on a manufacturer usage description (MUD) uniform resource identifier (URI) included in the profiling information and indicating the type of the device.

8. The system of claim 1, wherein the profiling information associated with the device includes at least one of:
an identifier associated with the device;
an internet protocol (IP) address associated with the device;
a manufacturer associated with the device;
one or more capabilities associated with the device; or
power over ethernet (PoE) information associated with the device.

9. A method comprising:
receiving, at a network controller associated with a network and from a profiling server associated with the network, profiling information associated with a device that has made an initial connection to the network;
determining, based at least in part on the profiling information, a type associated with the device;
querying a database to identify a workflow associated with on-boarding the device based at least in part on the type associated with the device;
sending, from the network controller and to a language model associated with the network, a request for a configuration script associated with configuring the device with the network, the request including the workflow associated with on-boarding the device and the profiling information associated with the device;
receiving, at the network controller and from the language model, the configuration script associated with the device, the configuration script being associated with a network port of a switch connecting the device to the network; and
configuring, by the network controller, the network port associated with the device based at least in part on execution of the configuration script.

10. The method of claim 9, wherein the language model is configured as a generative artificial intelligence (AI) model comprising at least one of:
a large language model (LLM);
a medium language model (MLM); or
a small language model (SLM),
wherein at least one of the MLM or the SLM is generated as a result of one or more distillation processes performed with respect to the LLM based at least in part on input received from an administrator of the network.

11. The method of claim 9, wherein configuring the network port associated with the device based at least in part on execution of the configuration script comprises at least one of:
assigning the device to an overlay network associated with the network;
assigning the device to a virtual local area network (VLAN) associated with the network;
configuring one or more quality of service (QoS) attributes associated with the device; and
configuring the network port with one or more security services associated with the device.

12. The method of claim 9, wherein:
the device is assigned a first virtual local area network (VLAN) associated with the network during the initial connection to the network, the first VLAN being configured as a quarantine VLAN; and
the device is assigned a second VLAN associated with the network following execution of the configuration script, the second VLAN granting greater access to the network than the first VLAN.

13. The method of claim 9, wherein the device is at least one of:
a non-human device configured as at least one of:
an internet of things (IoT) device;
a camera;
a sensor;
a human machine interface (HMI); or
a programmable logic controller (PLC); or
a human device under control of one or more users configured as at least one of:
a mobile device; or
a personal computing device.

14. The method of claim 9, wherein determining the type associated with the device is further based at least in part on a manufacturer usage description (MUD) uniform resource identifier (URI) included in the profiling information and indicating the type of the device.

15. The method of claim 9, wherein the profiling information associated with the device includes at least one of:
an identifier associated with the device;
an internet protocol (IP) address associated with the device;
a manufacturer associated with the device;
one or more capabilities associated with the device; or
power over ethernet (PoE) information associated with the device.

16. One or more non-transitory computer-readable media storing instructions that, when executed by one or more processors, cause the one or more processors to perform operations comprising:
receiving, at a network controller associated with a network and from a profiling server associated with the network, profiling information associated with a device that has made an initial connection to the network;
determining, based at least in part on the profiling information, a type associated with the device;
querying a database to identify a workflow associated with on-boarding the device based at least in part on the type associated with the device;
sending, from the network controller and to a language model associated with the network, a request for a configuration script associated with configuring the device with the network, the request including the workflow associated with on-boarding the device and the profiling information associated with the device;
receiving, at the network controller and from the language model, the configuration script associated with the device, the configuration script being associated with a network port of a switch connecting the device to the network; and
configuring, by the network controller, the network port associated with the device based at least in part on execution of the configuration script.

17. The one or more non-transitory computer-readable media of claim 16, wherein the language model is configured as a generative artificial intelligence (AI) model comprising at least one of:
a large language model (LLM);
a medium language model (MLM); or
a small language model (SLM),
wherein at least one of the MLM or the SLM is generated as a result of one or more distillation processes performed with respect to the LLM based at least in part on input received from an administrator of the network.

18. The one or more non-transitory computer-readable media of claim 16, wherein configuring the network port associated with the device based at least in part on execution of the configuration script comprises at least one of:
assigning the device to an overlay network associated with the network;
assigning the device to a virtual local area network (VLAN) associated with the network;
configuring one or more quality of service (QoS) attributes associated with the device; and
configuring the network port with one or more security services associated with the device.

19. The one or more non-transitory computer-readable media of claim 16, wherein:
the device is assigned a first virtual local area network (VLAN) associated with the network during the initial connection to the network, the first VLAN being configured as a quarantine VLAN; and
the device is assigned a second VLAN associated with the network following execution of the configuration script, the second VLAN granting greater access to the network than the first VLAN.

20. The one or more non-transitory computer-readable media of claim 16, wherein the device is at least one of:
a non-human device configured as at least one of:
an internet of things (IoT) device;
a camera;
a sensor;
a human machine interface (HMI); or
a programmable logic controller (PLC); or
a human device under control of one or more users configured as at least one of:
a mobile device; or
a personal computing device.
